(19) United States
(12) Patent Application Publication
(10) Pub. No.: US 2025/0003498 A1
(43) Pub. Date: Jan. 2, 2025

(54) SLIDE RING OF A MECHANICAL SEAL AND METHOD FOR THE PRODUCTION THEREOF

(71) Applicant: EagleBurgmann Germany GmbH & Co., KG, Wolfratshausen (DE)

(72) Inventors: Robert Suszniak, Münsing (DE); Stefanie Kreft, München (DE)

(73) Assignee: EagleBurgmann Germany GmbH & Co., KG, Wolfratshausen (DE)

(21) Appl. No.: 18/709,630

(22) PCT Filed: Oct. 17, 2022
(86) PCT No.: PCT/EP2022/078800

§ 371 Date: May 13, 2024

(30) Foreign Application Priority Data
Dec. 7, 2021 (DE) 10 2021 132 117.4

(51) Int. Cl. F16J 15/34

(52) U.S. Cl. CPC F16J 15/3496; F16J 15/3492

(57) ABSTRACT

The invention relates to a slide ring of a mechanical seal assembly, comprising a sintered, ceramic ring (41) having a slide surface (4a), which ring is made of an electrically non-conductive ceramic material, a contact body (42), which is configured for electrical contact and is arranged in the ring (41), wherein the electrical contact body (42) is made of a sintered ceramic material which is electrically conductive, and wherein the electrical contact body (42) is arranged in an recess (40) in the ring (41) and fills the recess (40).

The present invention relates to a slide ring of a mechanical seal, to a mechanical seal assembly, and to a method for producing the slide ring.

Slide rings of mechanical seals are known from the prior art in different configurations. Recently, sensor systems have been being increasingly arranged on a slide surface of a slide ring to monitor the slide ring, for example its wear. This gives rise to a problem area in that the sensor system on the slide surface has to be electrically contacted. Since the sensor system is on the slide surface, it is necessary for there to be electrical throughplating through the slide ring. Since a very brittle ceramic is often used as the material for the slide ring, bores or the like, which have to be made in the slide ring to allow for electrical contacting, pose a risk in particular in that there is the risk of damage to and cracks in the slide ring arising that are not visible. Furthermore, slide rings are readily coated on their slide surfaces, for example with a diamond coating. In this case, however, bores in the slide ring that extend to the slide surface are highly disadvantageous, even when they are filled with a material, since the coating often becomes detached at the edges of the bores. Since a coating is usually produced as the last step in producing the slide ring, very high process temperatures of up to 900° C. occur during diamond coating, for example. This results in thermotechnical problems for low-melting metals that are potentially present in the slide ring for electrical contacting since the melting points of such metals are considerably below the coating temperatures.

The object of the present invention is therefore to provide a slide ring, a mechanical seal assembly and a method for producing a slide ring which allow for reliable electrical contacting between the sensor system and the slide surface of the slide ring while being simple in structure and simple and cost-effective to produce and carry out.

The object is achieved by means of a slide ring having the features of claim 1, by means of a mechanical seal assembly having the features of claim 12, and by means of a method having the features of claim 13. The dependent claims each disclose preferred developments of the invention.

Compared with the prior art, the claimed slide ring of a mechanical seal assembly having the features of claim 1 provides the advantage that simplified, reliable electrical contacting through a slide ring is possible. In this way, in particular sensors which are arranged on or close to a slide surface of the slide ring or in the slide ring can be electrically contacted. For example, however, it is also possible for an electrical circuit to be guided through the slide ring which, for example, can be used for a wear measurement when the electrical circuit is arranged such that, when there is wear to the slide surface of the slide ring, the electrical circuit is broken in the event of wear that has progressed to a corresponding extent. In this case, the slide ring can be made of an electrically non-conductive ceramic material, which is advantageous in terms of suitability as a slide ring material. This is achieved according to the invention in that the slide ring comprises a sintered, ceramic ring having a slide surface, wherein the ceramic ring is made of an electrically non-conductive ceramic material. Furthermore, an electrical contact body is provided which is arranged in the ring for electrical contacting. Here, the electrical contact body is made of a sintered ceramic material which is electrically conductive. In this case, the electrical contact body is arranged in a recess in the ring and fills the recess at least in part, preferably completely. Therefore, a ceramic slide ring can be provided which is electrically conductive only in the region of the electrical contact body by introducing the electrical contact body. Since both the ring and the contact body are made of a ceramic material, for example in comparison with a slide ring in which a metal material is arranged as the electrical line, this results in considerable advantages in operation, since the heat developing during operation of the mechanical seal assembly results in a very even change in volume in the ring and in the electrical contact body in the slide ring according to the invention.

Particularly preferably, a plurality of chemical bonds produced by sintering are formed between the electrical contact body and the ring. This ensures that the contact body is securely fixed in the ring, and also thermally induced changes in volume in the ring and the contact body are particularly evenly implemented as a result. It should be noted here that the contact body and the ring can be sintered together in one step or, alternatively, the ring is pre-sintered and then the material of the contact body is introduced into the recess and then, in a second sintering step, the pre-sintered ring and the material of the contact body are re-sintered.

The recess in the ring is preferably a through-recess. In this case, the through-recess can extend from a rear surface to the slide surface, in particular in a straight line, or alternatively from an inner circumferential surface or an outer circumferential surface to the slide surface. As a result, electrical contacting of the slide ring with the circumferential surfaces is possible, and this is advantageous in some constructions of mechanical seal assemblies.

Particularly preferably, the contact body comprises a blind hole which is filled with an electrically conductive metal material. In this case, the blind hole is arranged on an exit side of the contact body, for example on a rear surface of the slide ring. As a result, simple electrical contacting of the electrical contact region of the slide ring is made possible. For example, an electrical line to a measuring apparatus or a computer or the like can be attached to the electrically conductive metal material by soldering or welding without the ceramic material of the slide ring being damaged. This can also prevent undesired voltages from being introduced into the slide ring owing to electrical contacting of the contact region.

The electrically conductive metal material is preferably a metal pin, which is inserted into the blind hole in the electrical contact body by means of a press fit. As a result, the metal pin can be fixed in the electrical contact body in a simple and secure manner.

Particularly preferably, the metal region forms an electrical terminal for the electrical contact body on the exit side of the contact body, to which terminal an electrical line can be attached in a simple manner by soldering or welding.

More preferably, the slide ring comprises a sensor which is arranged on the slide ring and is electrically connected to the electrical contact body. As a result, the sensor can be electrically contacted in a simple and reliable manner and the slide ring can still be made of a ceramic material. The sensor is preferably arranged on a slide surface of the slide ring. Here, a recess in the slide surface of the slide ring can be provided in which the sensor is arranged. The electrical contact body can then extend to the recess and electrically contact the sensor.

In this case, the slide ring is preferably a stationary slide ring of the mechanical seal assembly and comprises two electrical contact bodies in the ring of the slide ring in order to allow electrical contacting of the sensor by means of a closed circuit. Here, the first of the contact bodies is an electrical feed line, and the second of the contact bodies is an electrical return line.

According to another preferred configuration of the invention, the slide ring comprises a coating. The coating can be a diamond coating or a titanium nitride coating, for example. Coated slide rings are preferably used because a service life of the slide ring can be extended by reduced wear by means of a coating on the slide surface of the slide ring. A problem area when coating a slide surface of a slide ring is, however, that very high process temperatures are usually required for this purpose, for example of up to 900° C. for a diamond coating. Metals which are provided in a slide ring for electrical contacting melt at these high temperatures of approx. 900° C., however. As a result, it has not previously been possible to provide coated slide rings with a sensor, in particular a wear sensor since electrical contacting of the sensor is not possible by means of the standard contacting processes. Subsequently introducing electrical contacting, for example providing a bore in the ceramic ring after applying the coating, is, however, very difficult and entails high costs, and there is always the risk that the ceramic slide ring will develop cracks or the coating will become damaged, meaning that the reject rate when producing this kind of coated ceramic slide ring comprising electrical lines is very high and is generally uneconomical.

The ceramic ring of the slide ring is preferably made of SiC, which is an electrically non-conductive material, i.e. has an electrical conductivity of ≤10⁻⁸ S/m at 20° C. Si—SiC, i.e. silicon-infiltrated SiC, or doped SiC, which has electrical conductivity, or SiC—C—Si, i.e. SiC infiltrated with carbon and silicon, is preferably used as the material for the electrical contact body.

Furthermore, the present invention relates to a mechanical seal assembly comprising a slide ring according to the invention. The slide ring according to the invention is preferably used as a stationary slide ring of the mechanical seal assembly. The mechanical seal assembly particularly preferably comprises a sensor on the stationary slide ring which is electrically connected to a measuring apparatus by the electrical contact body. The sensor is in particular a wear sensor.

The present invention relates to a method for producing a slide ring, in particular a stationary slide ring, of a mechanical seal assembly. This method comprises the steps of:
producing an annular green body from an electrically non-conductive ceramic material,
making a recess in the green body,
filling the recess in the green body with an electrically conductive, ceramic material, and
sintering the green body having the filled recess.

By means of the method according to the invention, a ceramic slide ring of a mechanical seal assembly can thus be produced which is electrically non-conductive but comprises an electrically conductive contact body by way of the sintered electrically conductive ceramic material, i.e. the material found in the recess. In this method, the advantages described above for the slide ring are obtained.

In the method according to the invention, the green body is preferably pre-sintered after making the recess in the green body. The electrically conductive ceramic material is then introduced into the recess and a second sintering (re-sintering) is then performed in order to obtain the ceramic slide ring having a ceramic, electrical contact body. The slide ring can thus be obtained by sintering in two steps.

A coating, in particular a diamond coating, is preferably applied to a slide surface of the slide ring after sintering the slide ring. More preferably, a blind hole is made in the electrical contact body in the slide ring after the sintering, which hole is filled with electrically conductive metal material, preferably in the form of a metal pin pressed into the cut-out.

In the following, preferred exemplary embodiments of the invention will be described in detail with reference to the accompanying drawings, in which:

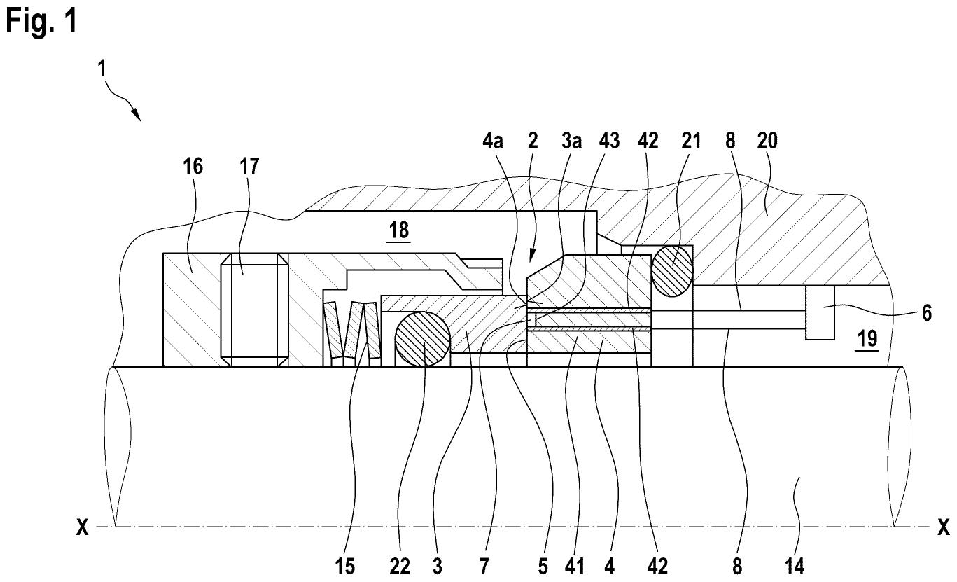

FIG. 1 is a schematic sectional view of a mechanical seal assembly comprising a slide ring according to the invention in accordance with a first exemplary embodiment of the invention,

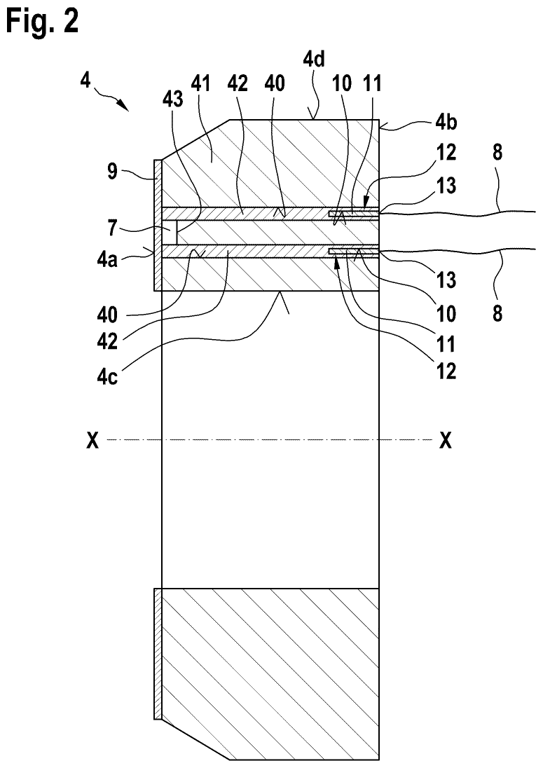

FIG. 2 is a schematic sectional view of the slide ring according to the invention from FIG. 1,

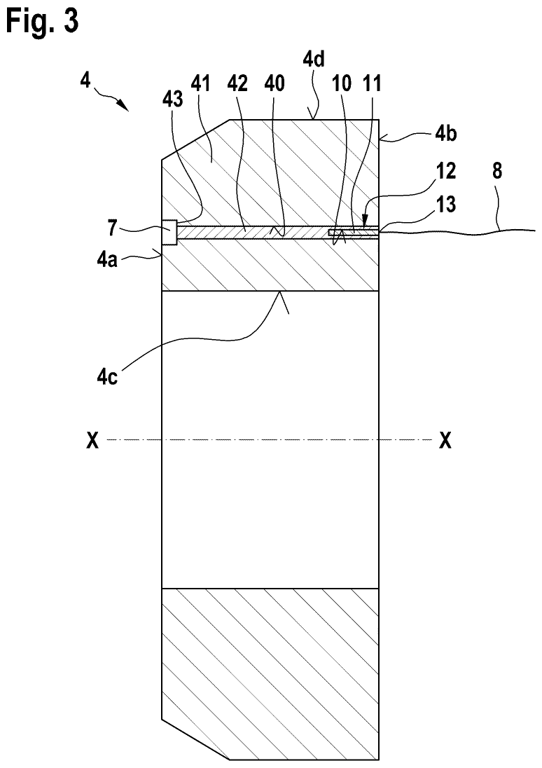

FIG. 3 is a schematic sectional view of a slide ring according to a second exemplary embodiment of the invention, and

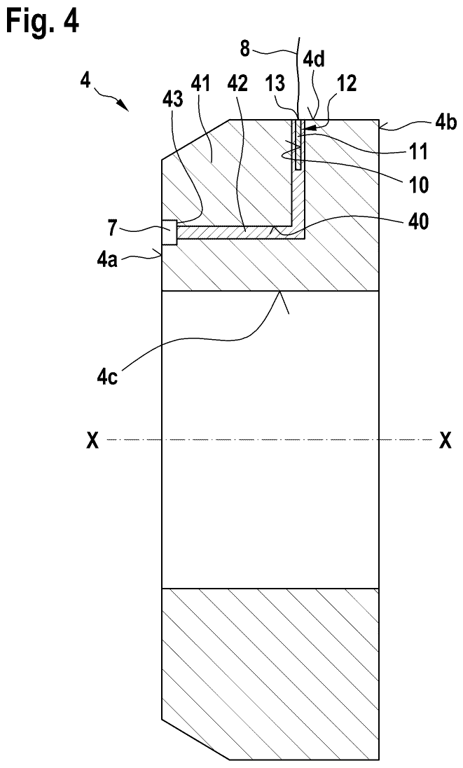

FIG. 4 is a schematic sectional view of a slide ring according to a third exemplary embodiment of the invention.

In the following, with reference to FIGS. 1 and 2, a mechanical seal assembly 1 according to a first preferred exemplary embodiment of the invention is described in detail.

As shown in FIG. 1, the mechanical seal assembly 1 comprises a mechanical seal 2 comprising a rotating slide ring 3 and a stationary slide ring 4. The rotating slide ring 3 comprises a first slide surface 3a and the stationary slide ring 4 comprises a second slide surface 4a.

A sealing gap 5 is defined between the two slide surfaces 3a, 4a of the slide rings 3, 4. Here, the mechanical seal assembly 1 seals a region 18 in which a product to be sealed is found from an atmosphere region 19 on a shaft 14. In this case, the rotating slide ring 3 is connected to the shaft 14 for conjoint rotation by means of a slide ring carrier 16 and a screw 17.

Furthermore, a pre-tensioning element 15 is provided which pre-tensions the rotating slide ring 3 in an axial direction of a central axis X-X against the stationary slide ring 4.

The stationary slide ring 4 is sealed against a stationary housing component 20 by means of a first O-ring 21. The rotating slide ring 3 is sealed to the shaft 14 on its inner circumference by means of a second O-ring 22.

The mechanical seal assembly 1 further comprises a measuring apparatus 6, which is in particular configured for measuring wear to the stationary slide ring 4 on its slide surface 4a. The measuring apparatus 6 is connected to a sensor 7 here. The sensor 7 is arranged on the slide surface 4a of the stationary slide ring 4.

The sensor 7 is arranged in an indentation 43 in the slide surface and is preferably a wear sensor.

Electrical contact of the sensor 7 with the slide surface 4a has to be provided for this purpose, and this is shown in detail in FIG. 2. As shown in FIG. 2, the stationary slide ring 4 comprises a sintered, ceramic ring 41, which is made of an electrically non-conductive ceramic material, in particular SiC. Furthermore, two identically constructed electrical contact bodies 42 which are made of a sintered ceramic material that has electrical conductivity, in particular made of silicon-infiltrated SiC (Si—SiC), are arranged in the ring 41.

As shown in FIG. 2, the contact regions 42 extend from a rear surface 4b to the slide surface 4a. A coating 9 is provided on the slide surface 4a. The electrical contact bodies 42 are arranged in recesses 40 made in the ring 41 and extend in a straight line through the slide ring 4.

The electrical contact bodies 42 each comprise an electrical terminal 13 for an electrical line 8 on an exit side on the rear surface 4b of the slide ring 4. In this case, the electrical terminal 13 is formed such that, in the electrical contact body 42, a blind hole 10 is provided, which is open towards the rear surface 4b of the stationary slide ring 4 and is filled with a metal material in the form of a metal pin 11. A press fit 12 is formed between the metal pin 11 and the cut-out 10.

In other words, the electrical contact body 42 comprises a blind hole 10 filled with the metal pin 11 on the surface directed towards the rear surface of the slide ring 4 such that the metal pin 11 can electrically contact the electrical contact body 42. As shown in FIG. 1, the two electrical contact bodies 42 are electrically connected to the measuring apparatus 6 by the electrical lines 8, and therefore the sensor 7 is also electrically connected to the measuring apparatus 6.

In this case, the stationary slide ring 4 made of ceramic material can be produced such that, in a first step, an annular green body is provided according to the desired geometric design of the stationary slide ring 4 made of an electrically non-conductive ceramic material, e.g. SiC. The recesses 40 for the electrical contact bodies 42 are then made in the green body. In the next step, the recesses are filled with an electrically conductive, ceramic material, for example Si—SiC, which then form the electrical contact bodies 42 in the completed slide ring. In the next step, the green body is sintered. This in particular results in chemical bonds produced by the sintering between the material of the ring and the material of the contact body. As a result, the electrically conductive region in the form of the electrical contact bodies 42 is integrated in the slide ring.

When a sensor 7 is intended to be provided on the slide surface of the slide ring, for example, an accordingly formed indentation or the like is preferably made in the slide surface in which the sensor 7 is subsequently received. In this case, the electrical contact regions 42 then logically lead to the indentation in order to subsequently be able to electrically contact the sensor.

Since the thermal expansion of the ceramics of the ring 41 and the electrical contact body 42 is substantially identical, no components are weakened during thermal expansion in particular, as would be the case if a metal material were used for electrical contacting. Furthermore, this does not result in any temperature-dependent limitations when selecting the coating 9, either. In particular, a diamond coating that has to be applied at temperatures of approximately 900° C. can be provided.

Furthermore, the atomic bonds in the sintering step between the material of the ring 41 and the material of the electrical contact bodies 42, in particular on the slide surface, result in flush joints, such that the slide ring has excellent smoothness and there is in particular a seamless transition between the ring material and the material of the electrical contact region.

The atomic bond between the electrically non-conductive ceramic material of the ring 41 and the electrically conductive, ceramic material of the contact body 42 also in particular results in considerably improved emergency running properties, in particular in particular in terms of a possible emergency running duration, since there is still a planar, in particular edge-free surface at the transition between the two materials on the slide surface 4a after wear of a coating 9, for example, which surface can be used as the slide surface for the emergency running.

Therefore, a stationary slide ring 4 can be provided which for example comprises a wear sensor 7 on the slide surface and a coating 9 in the form of a diamond coating. In this case, the sensor contacting is integrated in the ring and is ensured by a gliding, ceramic material. By means of the metal pin 11 in the electrically conductive material, particularly simple thermal electrical contacting can also be provided by welding or soldering directly to the slide ring without the slide ring being damaged.

FIG. 3 shows a slide ring 4 of a mechanical seal assembly according to a second exemplary embodiment of the invention. Identical or functionally identical parts are provided with the same reference characters as in the first exemplary embodiment.

By contrast with the first exemplary embodiment, the slide ring in the second exemplary embodiment does not have a coating. A sensor 7 is directly arranged on the slide surface 4a of the stationary slide ring 4. The sensor 7 is electrically contacted on a rear surface of the sensor by an electrical contact body 42. This is done in the same way as in the first exemplary embodiment and is produced by an electrically conductive ceramic material. A metal pin 11 is attached to the rear surface 4b, i.e. the exit side, of the electrical contact body 42 for simple electrical contacting. Otherwise, this exemplary embodiment corresponds to the preceding exemplary embodiment, and therefore reference can be made to the description of that exemplary embodiment.

FIG. 4 shows a slide ring 4 according to a third exemplary embodiment of the invention. Identical or functionally identical parts are provided with the same reference characters as in the preceding exemplary embodiments.

As is immediately clear from FIG. 4, in the third exemplary embodiment, the electrical contacting is provided on an outer circumferential surface 4d instead of on the rear surface 4b. The recess 40 thus forms a 90° angle in the ring 41. This can be provided by making two bores in the ceramic ring 41, for example. It should be noted that electrical contacting would also be possible on an inner circumferential surface 4c in the same way. When providing two points of electrical contacting, it would also be conceivable to form one point of electrical contacting on the outer circumferential surface 4d and one point of electrical contacting on the inner circumferential surface 4c. Furthermore, it goes without saying that a combination with contacting on the rear surface 4b of the stationary slide ring 4 and one of the circumferential surfaces 4c, 4d would also be conceivable. Otherwise, this exemplary embodiment corresponds to the preceding exemplary embodiments, and therefore reference can also be made to the description of that exemplary embodiment.

In addition to the above written description of the invention, in order to provide supplementary disclosure reference is hereby explicitly made to the drawings of the invention in FIGS. 1 to 4.

### LIST OF REFERENCE CHARACTERS

1 Mechanical seal assembly
2 Mechanical seal
3 Rotating slide ring
3a First slide surface
4 Stationary slide ring
4a Second slide surface
4b Rear surface
4c Inner circumferential surface
4d Outer circumferential surface
5 Sealing gap
6 Measuring apparatus
7 Sensor
8 Electrical line
9 Coating
10 Blind hole in the contact body
11 Metal pin
12 Press fit
13 Electrical terminal
14 Shaft
15 Pre-tensioning element
16 Slide ring carrier
17 Screw
18 Region in which the product to be sealed is found
19 Atmosphere region
20 Housing component
21 First O-ring
22 Second O-ring
40 Recess
41 Electrically non-conductive ceramic ring
42 Electrically conductive contact body
43 Indentation in the slide surface
X-X Central axis

1. Slide ring of a mechanical seal assembly, comprising
a sintered, ceramic ring having a slide surface, which ring is made of an electrically non-conductive ceramic material, and
an electrical contact body, which is configured for electrical contacting and is arranged in the ring,
wherein the electrical contact body is made of a sintered ceramic material which is electrically conductive, and
wherein the electrical contact body is arranged in a recess in the ring and fills the recess.

2. Mechanical seal according to claim 1, wherein chemical bonds produced by sintering are formed between the electrical contact body and the ring.

3. Slide ring according to claim 1, wherein the recess is a through-recess which extends from a rear surface to the slide surface or extend from an inner circumferential surface or an outer circumferential surface to the slide surface.

4. Slide ring according to claim 1, wherein the contact body comprises a blind hole on an exit side of the contact body which is facing away from the slide surface and is filled with an electrically conductive metal material.

5. Slide ring according to claim 4, wherein the electrically conductive metal material is a metal pin, wherein a press fit is formed between the metal pin and the blind hole.

6. Slide ring according to claim 4, wherein an electrical line is electrically connected to the electrical contact body at a terminal formed by an exposed region of the electrical metal material.

7. Slide ring according to claim 1, further comprising a sensor which is arranged on the slide ring and is electrically connected to the electrical contact body.

8. Slide ring according to claim 7, wherein the sensor is arranged on the slide surface of the slide ring.

9. Slide ring according to claim 7, wherein the slide ring is a stationary slide ring of the mechanical seal assembly and two contact bodies are provided in the ring for electrically contacting the sensor.

10. Slide ring according to claim 1, wherein the slide surface of the ring is coated with a coating.

11. Slide ring according to claim 1, wherein the ring is made of SiC and the electrical contact body is made of Si—SiC or doped SiC or SiC—C—Si.

12. Mechanical seal assembly, comprising a stationary slide ring in accordance with claim 1 and a measuring apparatus, which is electrically connected to the contact body of the slide ring.

13. Method for producing a slide ring, comprising the steps of:
producing an annular green body from an electrically non-conductive ceramic material,
making a recess in the green body,
filling the recess with an electrically conductive, ceramic material, and
sintering the green body and the introduced ceramic material such that a ceramic slide ring comprising an electrically non-conductive ceramic ring and an electrically conductive, ceramic contact body is produced.

14. Method according to claim 13, wherein after making the recess in the green body, the green body is pre-sintered and the electrically conductive ceramic material is introduced into the recess after the pre-sintering, and subsequently the pre-sintered green body and the ceramic material introduced into the recess are re-sintered.

15. Method according to claim 13, wherein a coating is applied to the slide surface of the slide ring after the sintering.

16. Method according to claim 13, wherein after the sintering, a blind hole is made in the contact body made of the electrically conductive ceramic material and the blind hole is filled with an electrically conductive metal in order to provide the option of electrical contacting at the introduced metal.
